(19) United States
(12) Patent Application Publication
(10) Pub. No.: US 2013/0007043 A1
(43) Pub. Date: Jan. 3, 2013

(54) VOICE DESCRIPTION OF TIME-BASED MEDIA FOR INDEXING AND SEARCHING

(76) Inventors: Michael E. Phillips, Melrose, MA (US); Paul J. Gray, Cambridge, MA (US)

(21) Appl. No.: 13/173,669

(22) Filed: Jun. 30, 2011

(51) Int. Cl. G10L 21/00; G06F 17/30

(52) U.S. Cl. 707/769; 704/201; 704/E11.001; 707/E17.014

(57) ABSTRACT

Methods and systems for time-synchronous voice annotation of video and audio media enable effective searching of time-based media content. A user record one or more types voice annotation onto corresponding named voice annotation tracks, which are stored within a media object comprising the time-based media and the annotations. The one or more annotation tracks can then be selectively searched for content using speech or text search terms. Various workflows enable voice annotation to be performed using media editing systems, or one or more stand alone voice annotations systems that permit multiple annotators to operate in parallel, generating different kinds of annotations, and returning their annotation tracks to a central location for consolidation.

### BACKGROUND

Editors, broadcasters, and media archivists have a need to search their media assets. Yet time-based media are notoriously difficult to search because of their sequential nature, and because of the difficulty of generating effective search terms that can be matched against video imagery and audio content. Media asset management systems address the problem by enabling users to create various descriptive text metadata fields for association with media files, such as date, author/composer, etc. Although this provides a means of searching for media files based on their global properties, such searches do not tap directly into the content of the media. Structural metadata provides another set of searchable criteria, but again, searches based on structural metadata return results based on various technical qualities of the media, and do not access the media content. Furthermore, such searches are prone to false negatives and false positives if terms are not properly spelled, either in the metadata or in the search string.

As the quantity and diversity of media being generated, stored, and searched continues to increase rapidly, the need for effective searching of media content becomes ever more important.

### SUMMARY

In general, the methods, systems, and computer program products described herein enable users of media editing and media annotation systems to create voice descriptions of time-based media content that are temporally keyed to the described media. Multiple voice description tracks can be recorded to enable various different aspects of the media to be annotated. With such voice description metadata, time-based media can be rapidly and effectively searched based on one or more of the types of description featured in the description tracks.

In general, in one aspect, a method of associating a voice description with time-based media, the time-based media including at least one media track, includes: enabling a user of a media editing system to record the user's voice description of the time-based media while using the media editing system to play back the time-based media; creating a voice description audio track for storing the voice description; and storing the recorded voice description in the voice description audio track, wherein the voice description audio track is temporally synchronized with the at least one media track, and wherein the at least one media track and the voice description track are stored within a single media object.

Various embodiments include one or more of the following features. The user is able to create an identifier for the voice description audio track. The media editing system receives a search term, searches the voice description track for the search term, and if one or more matches to the search term are found, displays an indication of one or more spans within the time-based media having temporal locations corresponding to the temporal locations of the one or more matches in the voice description track. The search term is received as speech or in text form. A user of the media editing system is able to record a second voice description of the time-based media while using the media editing system to play back the time-based media, the system creates a second voice description audio track for storing the second voice description, and the system stores the second recorded voice description in the second voice description audio track, which is temporally synchronized with the at least one media track, wherein the second voice description track is stored as a component of the media object. The media editing system receives a search term, the user is able to select one or both of the first-mentioned and second voice description tracks for searching; searching the selected voice description tracks for the search term; and if one or more matches to the search term are found, displaying an indication of one or more spans within the time-based media having temporal locations corresponding to the temporal locations of the one or more matches in the selected voice description tracks. The media editing system plays back the media faster than real time during recording of the user's voice description. The user is further able to pause the play back of the media at a selected frame of the media and record a voice description of at least one of the selected frame and a span of frames that includes the selected frame. The user is further able to pause during the play back of the time-based media and terminate pausing and continue to record the voice description into the voice description track. The media track is a video track or an audio track. A temporal length of the voice description track is different from a temporal length of the media track. The voice description track includes an introductory portion prior to a start time of the media track, and the user records descriptive material relating to the media track into the introductory portion of the voice description track.

In general, in another aspect, a method of associating a voice description with time-based media, the time-based media including at least one media track, includes: receiving the time-based media at a media annotation system; enabling a user of the media annotation system to record the user's voice description of the time-based media while using the media annotation system to play back the time-based media; receiving from the user an identifier for an audio description track for storing the user's voice description; creating the audio description track that is tagged by the identifier; storing the voice description in the audio description track in association with the at least one media track as a component of a media object comprising the media track and the audio description track, wherein the audio description track is temporally synchronized with the at least one media track; and outputting the media object from the voice annotation system.

In general, in a further aspect, a computer system for voice annotation of time-based media includes: an input for receiving the time-based media, wherein the time-based media includes at least one media track; an audio input for receiving voice annotation from a user of the voice annotation system; an output for exporting the voice annotation; a processor programmed to: input via the audio input the user's voice annotation of the time-based media while playing back the time-based media using the media annotation system; input an identifier for an audio annotation track for storing the user's voice annotation; store the voice annotation in the audio annotation track as a component of a media object comprising the at least one media track and the audio annotation track, wherein the audio annotation track is temporally synchronized with the at least one media track; and export the media object from the voice annotation system.

In general, in yet another aspect, a computer program product includes: a computer-readable medium with computer program instructions encoded thereon, wherein the computer program instructions, when processed by a computer, instruct the computer to perform a method of enabling a user to annotate time-based media, wherein the time-based media includes at least one media track, the method comprising: receiving the time-based media at a media annotation system; enabling the user to record voice annotation of the time-based media while the computer is playing back the time-based media, creating an audio annotation track and tagging the audio annotation track with an identifier received from the user; storing the voice annotation in the audio annotation track, wherein the audio annotation track is stored as a component of a media object that comprises the at least one media track and the audio annotation track, and wherein the audio annotation track is temporally synchronized with the at least one media track; and exporting the media object.

### BRIEF DESCRIPTION OF THE DRAWINGS

FIG. 1 is a high level block diagram of a media editing system for voice annotation of time-based media.

FIG. 2 is a flow chart showing the main steps involved in voice annotation of time-based media.

FIG. 3 shows an example of portions of two different voice annotation tracks in which the speech is shown as text for illustrative purposes.

FIG. 4 is a diagram of a timeline representation of a media object including two media tracks of which one is a video track and the other is an audio track, and two voice annotation tracks.

FIG. 5 is a simplified illustration of a user interface for performing searches of time-based media using one or more voice annotation tracks.

FIG. 6 is a high level block diagram of a system with multiple voice annotation systems for facilitating voice annotation by multiple annotators.

FIG. 7 is a flow chart of a workflow involving multiple voice annotators.

### DETAILED DESCRIPTION

The ability to identify and locate a desired portion of time-based media presents a challenge for media editors, producers, and others involved in creating media compositions. One reason for this is the time-based nature of the media, which makes it impractical to search on an instantaneous, random access basis. Another reason is the nature of the media itself, namely video imagery and audio, which, unlike text, is generally not directly searchable using an explicit search string. In order to help alleviate this problem, various kinds of metadata, including structural metadata and descriptive metadata media, are used to help identify media. Such metadata generally apply to a media composition as a whole. In some cases, the metadata may have a finer granularity, referring to a subclip or a particular span within a given composition. However, the metadata does not reach inside a composition or constituent clip to enable a searcher to locate where content may be located within the clip, or to find content that is not described by the metadata. When a clip has a significant duration, and/or when many clips are being searched, such clip-based logging leaves the searcher with a time-consuming task of playing back the media returned by a search in order to locate a portion of interest by hand.

The methods and systems described herein address this problem by enabling media workers to voice annotate time-based media with one or more types of description that is temporally keyed to the media being described. Typically, the user records annotation or description using words, phrases, or full sentences using the user's plain natural language, e.g., English, but any word, including code words or other specialized words that are desired for later searching may be used. As used herein, the terms annotation and description in the context of voice annotation and voice description are used interchangeably. In the described embodiment, there is no need for the spoken words to be recognized as text, since the speech is later indexed and stored as phonemes, and searched by phoneme. The voice annotation and the original time-based media are combined into a single media object so that media editing systems need only keep track of a single object that includes all the original media as well as the audio annotation.

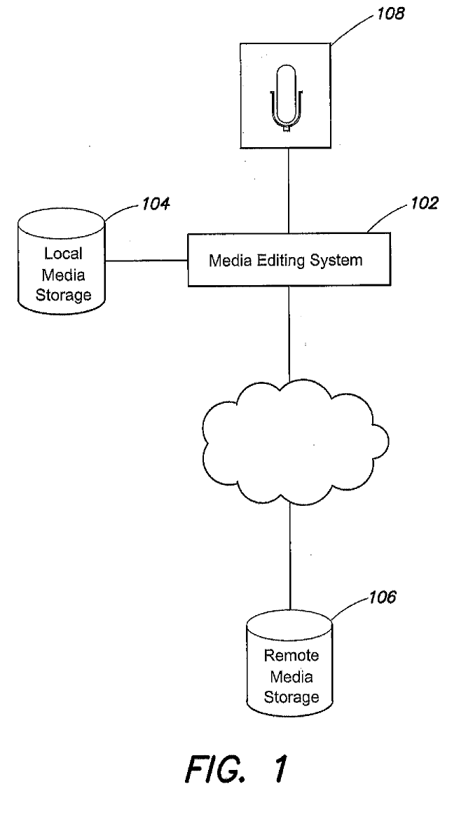

In the described embodiment, as illustrated in FIG. 1, voice annotation tools are provided as features of media editing system 102, which may be a non-linear media editing application that runs on a client, such as a computer running Microsoft Windows® or the Mac OS®. Examples of non-linear media editing applications include Media Composer® from Avid Technology, Inc. of Burlington, Mass., described in part in U.S. Pat. Nos. 5,267,351 and 5,355,450, which are incorporated by reference herein, and Final Cut Pro® from Apple Computer, Inc. of Cupertino Calif. The media editing system is connected to local media storage 104 by a high bandwidth network implemented using such protocols as Fiber Channel, InfiniBand, or 10 Gb Ethernet, and supporting bandwidths on the order of gigabits per second or higher. The media storage may include a single device or a plurality of devices connected in parallel. The media editing system is also connected via a network interface and optionally a local area network (not shown) to a wide area network, such as the Internet, enabling the system to transfer media data to and from remote media storage 106. The media editing system receives the time-based media to be annotated, either by retrieving the media from local media storage, or by downloading the media over the wide area network from remote media storage 106. The media editing system is also connected via a microphone input to microphone 108, which captures the users' voice annotation.

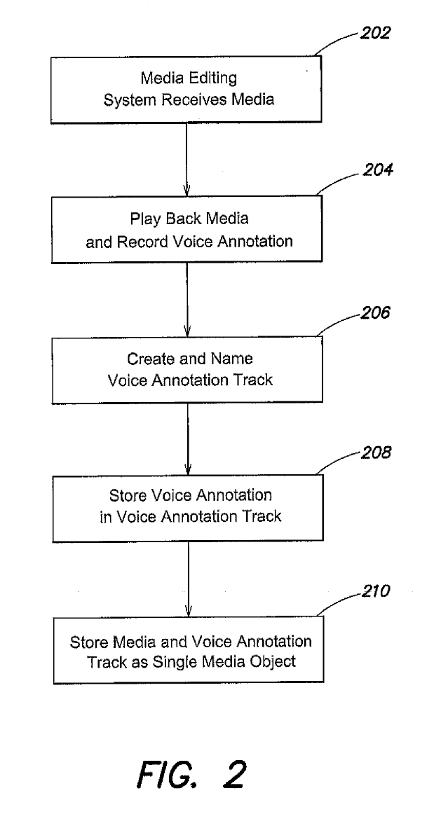

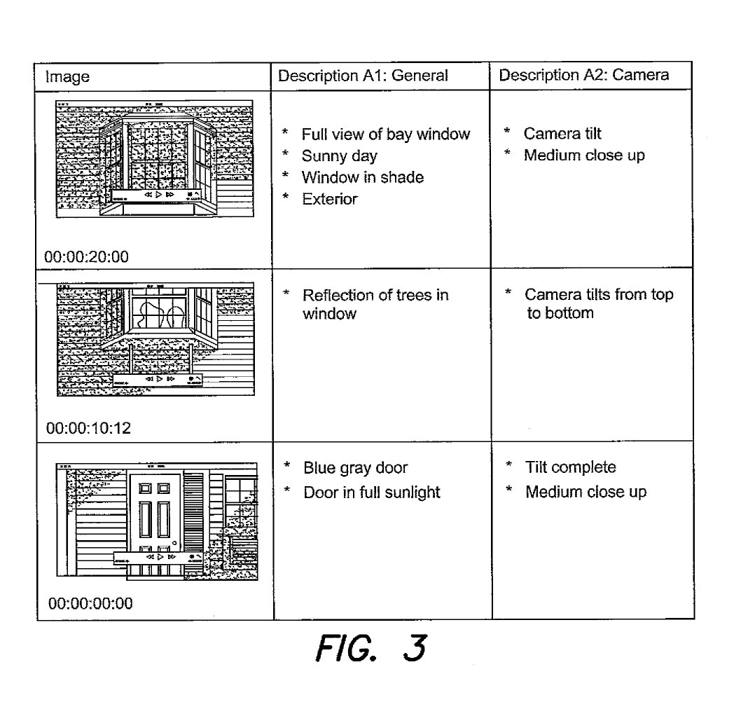

A high level flow diagram showing the main steps involved in the annotation of time-based media is shown in FIG. 2. The process starts with receiving the time-based media to be annotated (202). The media may be retrieved from local storage 104, or from a remote source, such as remote media storage 106 via a connection to a wide area network. The user of the media editing system then plays back the time-based media, and records voice annotation while viewing and/or listening to the media (204). The user speaks into connected microphone 108, and the microphone output is received by the media editing system, digitized and stored in a temporary file, while the recording proceeds. The user may back up and make changes and additions, with the changes being reflected in the temporary file. Once the annotation is complete, the media editing system provides a dialog for the user to create and name a voice annotation track for the recorded voice annotation (206). The ability to identify a voice annotation track with a name facilitates the creation of multiple tracks that can be readily distinguished, and enables annotation with more than one type of descriptive information. For example, a first audio annotation track may be named “General” and used to record a general description of the content of a scene, while a second audio annotation track may be named “Camera” for recording verbal notes on the camera shot. Such an example is illustrated in FIG. 3. Note that the text shown in the two illustrated annotation tracks, A1 and A2, are stored as speech or phonemes, not as text.

Once the user has completed recording a particular annotation track, or at an earlier time, the system stores the digitized speech in the voice annotation track (208). The track may be stored at a lower quality than that of audio tracks representing media essence, for example at 8 bit, 22 kHz versus a full 24 bit, 48 kHz. The voice annotation track is inserted as a component of a single media object that includes both the time-based media being annotated as well as the audio annotation track with the user's voice annotation. The media object preserves the temporal synchrony between the time-based media and the voice annotation, in this respect treating the voice annotation as it would an audio essence track. FIG. 4 illustrates media object 402 having two media tracks—video track V1 404 and audio track A1 406, as well as two voice annotation tracks, VA1 408 and VA2 410.

In certain embodiments, the audio annotation tracks are converted into phoneme audio tracks, and then indexed by phoneme. This process facilitates rapid searching for matches between speech within one or more audio annotation tracks and a search term, entered either directly as speech, or as text, either of which is converted into phonemes. Such audio search and matching techniques are described, for example, in U.S. Pat. No. 7,263,484, which is wholly incorporated herein by reference. Phonetic audio tracks corresponding to each of the voice annotation tracks 408, 410 may also be stored within media object 402, and are created either in real time as the voice annotation is being input, at the time the audio annotation is written into the voice annotation track, or at a later time, either automatically, or upon a user command.

In various embodiments, the user records the voice annotation while playing back the time-based media at a speed that is faster or slower than real time. Using a 2× or 3× playback speed accelerates the annotation process. The system maintains correct temporal synchrony between the voice annotation and the corresponding media, and stores the annotation along with the media, using pitch shifting of the annotation if needed, within media object 402. The user may also use a pause function to pause playback of the media, and then continue playback and voice annotation. In addition, the user may freeze the playback at a selected frame of video, and record an annotation of that frame, i.e., of a single point in time, or of a span of the time-based media that is shorter than the playback duration of the voice annotation. A visual indicator, such as a locator, is placed at the corresponding point on the media track of the timeline to highlight the presence of a single frame annotation. After one or more voice annotation tracks have been added to a media object, the time-based media may be searched by entering a search term which is to be searched for within one or more of the voice annotation tracks that the user selects for searching. As indicated above, the search is radically sped up and also made more robust when the annotation tracks have previously been converted into phonetic audio tracks, and indexed by phoneme sequence. The media editing system provides a search interface that enables the user to input the search terms either as speech or as text. Either form may be converted into a phoneme representation for searching against phonetic versions of the voice annotation tracks.

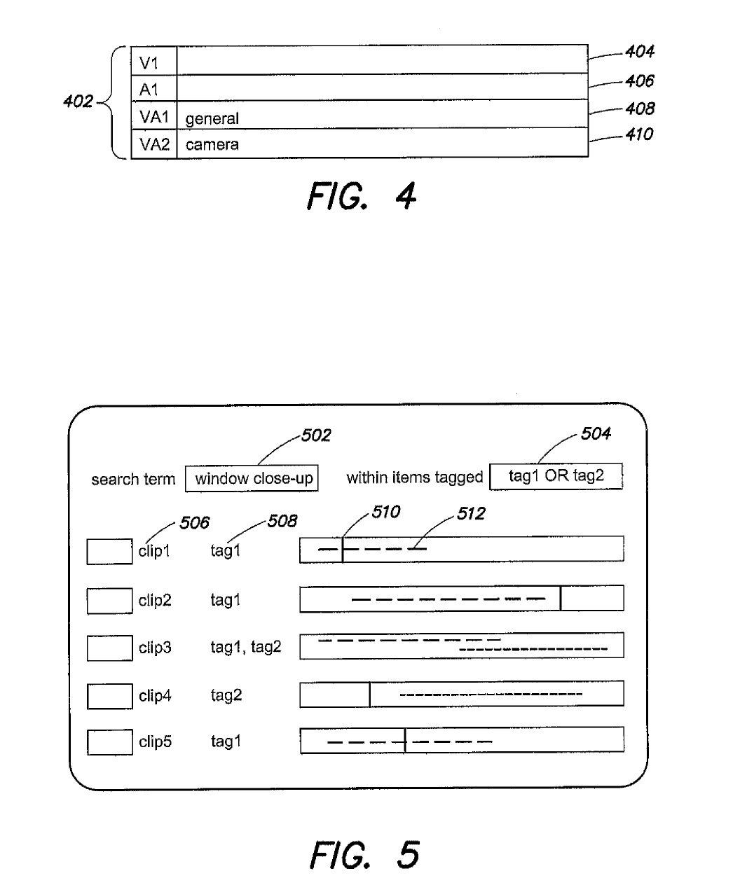

The search results are shown by displaying a visual indication of frames or spans of the time-based media that correspond to the matches to the search terms found within the voice annotation tracks. An illustrative graphical interface for the search is illustrated in FIG. 5. The user enters the term which is to be searched for in the selected audio voice annotation tracks in search box 502. The one or more audio voice annotation tracks, or any separately tagged portions of those tracks or tagged portions of the time-based media which are to be searched for the search term are selected by entering the tag names, or identifiers, given to the tracks into box 504. The search terms and tags to be searched may be combined with Boolean expressions. The results of the search corresponding to the terms and tags entered in boxes 502 and 504 respectively are shown in the lower portion of FIG. 5. Search results are displayed by indicating the name of the clip(s) containing matching speech (506), together with the tag name (identifier) of the annotation track that contained the match (508). For each clip containing a match, a timeline indicates locators (510) and spans (512) corresponding to the matched search terms. The search results illustrated in the figure include five different clips named clip1 to clip5, of which clip1, clip2, and clip5 include matches just in the annotation track named “tag1,” clip3 includes matched in tracks named “tag1” and “tag2,” and clip4 includes a match just in annotation track “tag2.” Locators 510, illustrated as vertical lines on the timeline, correspond to matching descriptions that have been associated with a single point in time, or with a span of media that is shorter than the duration of the associated annotation. The spans (512) show the temporal extent of the searched terms that have been located within the media clips. The span may be colored or shaded according to the particular tag to which they correspond.

In the embodiment described above, a media editing system provides the voice annotation as an additional feature within the context of a non-linear media editing system. The steps of enabling the user to input the annotation via an audio input device, such as a microphone, recording the voice, creating and naming one or more annotation tracks, and storing the annotation tracks as part of a single media object that comprises the time-based media and the annotation tracks, are all facilitated by the media editing system. We now describe some alternative systems and workflows for creating, consolidating, and searching voice annotations for time-based media.

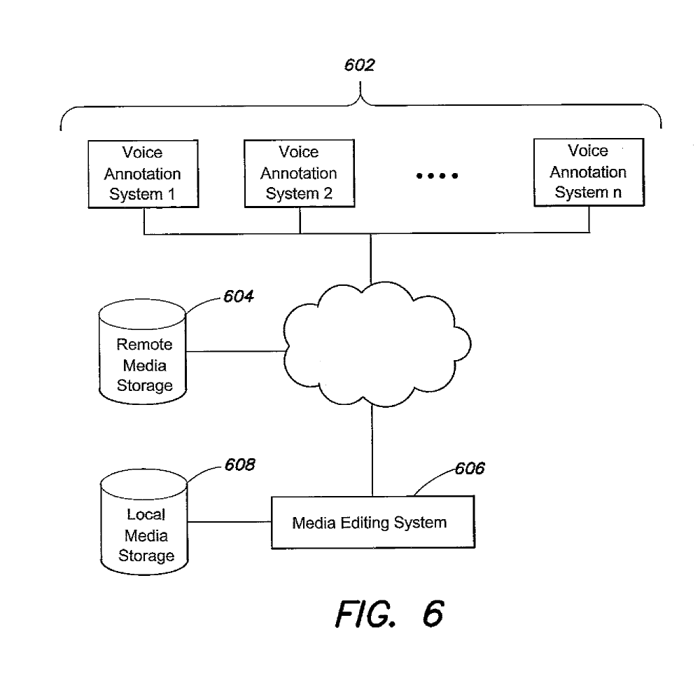

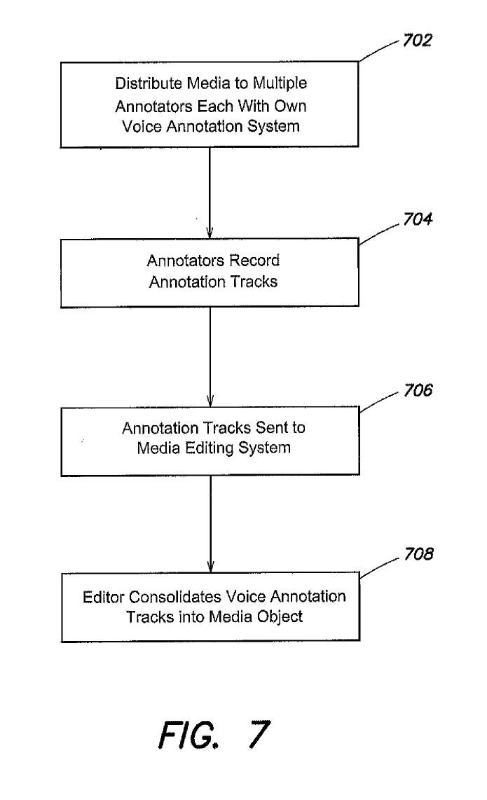

Since most of the functions of a media editing system are not required during the inputting of voice annotation, a standalone voice annotation system may be used instead. Such a system receives the media to be annotated, provides a microphone input and recording function, as well as media transport controls, and an output for sending the annotation tracks, optionally together with the original media, to local or remote storage, or to another system, such as a media editing system, for consolidation and the next steps in the production workflow. An advantage of this arrangement is that it does not tie up a full media editing station. In order to further distribute the voice annotation task, multiple voice annotation systems may be used, serially or in parallel, as illustrated in FIG. 6, which shows a plurality of voice annotation systems (602) connected to a wide area network, such as the Internet, over which the media to be annotated is received. The media may be stored on remote media storage 604, which may be a server farm, or cloud-based storage, or may be retrieved from media editing system 606, which in turn may access the media from its own local media storage 608. For example, as shown in the workflow illustrated in FIG. 7, the media to be annotated may be distributed to a first annotator using a first annotation system, who may be a logging assistant or librarian, for creating a general description track, and also in parallel to a second annotator using a second annotation system, who may be an additional assistant with training for a specific kind of logging being performed, such as creating a camera shot description track (702). The various annotators record their annotations and asynchronously create voice annotation tracks at their own convenience (704). Each of the voice annotation tracks is tagged with one or more identifiers that typically describe the nature of the annotation contained in the track, such as “general,” “camera,” “location,” or “people.” When the annotation is complete, each annotator forwards the recorded, tagged annotation track to a media editing system (706) or other media processing system, where the various annotation tracks are consolidated into a single media object having one or more tagged voice annotation tracks (708).

Voice annotation of media assists in making all forms of time-based media searchable. This applies to video-only media, media with both video and corresponding audio, and audio-only media. For media having one or more audio tracks, it is not necessary to avoid overlap between voice annotation and the original sound on the audio tracks, since during voice annotation, the audio tracks can be turned off, or can be listened to with headphones so as not to interfere with the recording of the annotation. During the search phase, the tracks to be searched are independently specified by the user, enabling the annotation tracks to be searched without any interference from any media audio tracks. This same feature applies also to audio-only media, limiting the search to tracks or portions of tracks having the specified one or more tags. For example, a simple search of “pan down” on “camera” track searched for “pan down” in the voice annotation on the track tagged with “camera.” This helps refine and filter the search resulting in more accurate responses.

Voice annotation tracks may comprise clips having durations that are different from those of the media they describe. For example, an introductory description can be recorded before the media itself begins, thereby extending the length of the annotation track by the duration of the introductory annotation. When no annotation is required for a section of a media track, the annotation track may be shortened—for example, if the part without annotation is at the end of the media, the annotation track can terminate before the media track ends, and have a shorter overall duration.

The various components of the system described herein may be implemented as a computer program using a general-purpose computer system or specialized device. Such a computer system may be a desktop computer, a laptop, a tablet, a portable device such as a phone (e.g., a stereo camera phone), other personal communication device, or an embedded system such as a camera with associated processor units. A voice annotation system may also be implemented by enabling a voice track to be recorded directly on an Electronic News Gathering (ENG) camera in the field, enabling an operator to provide a descriptive track during the original media acquisition.

Desktop systems typically include a main unit connected to both an output device that displays information to a user and an input device that receives input from a user. The main unit generally includes a processor connected to a memory system via an interconnection mechanism. The input device and output device are also connected to the processor and memory system via the interconnection mechanism.

One or more output devices may be connected to the computer system. Example output devices include, but are not limited to, liquid crystal displays (LCD), plasma displays, cathode ray tubes, video projection systems and other video output devices, printers, devices for communicating over a low or high bandwidth network, including network interface devices, cable modems, and storage devices such as disk or tape. One or more input devices may be connected to the computer system. Example input devices include, but are not limited to, a keyboard, keypad, track ball, mouse, pen and tablet, communication device, audio transducer such as a microphone, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media may be stored on and input from magnetic or optical discs, which may include an array of local or network attached discs.

A system such as described herein may be implemented in software or hardware or firmware, or a combination of the three. The various elements of the system, either individually or in combination may be implemented as one or more computer program products in which computer program instructions are stored on a non-transitory computer readable medium for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of associating a voice description with time-based media, the time-based media including at least one media track, the method comprising:
enabling a user of a media editing system to record the user's voice description of the time-based media while using the media editing system to play back the time-based media;
creating a voice description audio track for storing the voice description; and
storing the recorded voice description in the voice description audio track, wherein the voice description audio track is temporally synchronized with the at least one media track, and wherein the at least one media track and the voice description track are stored within a single media object.

2. The method of claim 1 further comprising enabling the user to create an identifier for the voice description audio track.

3. The method of claim 1, further comprising:
receiving a search term at the media editing system;
searching the voice description track for the search term; and
if one or more matches to the search term are found, displaying an indication of one or more spans within the time-based media having temporal locations corresponding to the temporal locations of the one or more matches in the voice description track.

4. The method of claim 3, wherein the search term is received as speech.

5. The method of claim 3, wherein the search term is received as text.

6. The method of claim 1, further comprising:
enabling the user of the media editing system to record a second voice description of the time-based media while using the media editing system to play back the time-based media;
creating a second voice description audio track for storing the second voice description; and
storing the second recorded voice description in the second voice description audio track, wherein the second voice description track is temporally synchronized with the at least one media track, and wherein the second voice description track is stored as a component of the media object.

7. The method of claim 6, further comprising:
receiving a search term at the media editing system;
enabling the user to select one or both of the first-mentioned and second voice description tracks for searching;
searching the selected voice description tracks for the search term; and
if one or more matches to the search term are found, displaying an indication of one or more spans within the time-based media having temporal locations corresponding to the temporal locations of the one or more matches in the selected voice description tracks.

8. The method of claim 1, wherein the media editing system plays back the media faster than real time during recording of the user's voice description.

9. The method of claim 1, further comprising enabling the user to:
pause the play back of the media at a selected frame of the media; and
record a voice description of at least one of the selected frame and a span of frames that includes the selected frame.

10. The method of claim 1, further comprising enabling the user to:
pause during the play back of the time-based media; and
terminate pausing and continue to record the voice description into the voice description track.

11. The method of claim 1, wherein the media track is a video track.

12. The method of claim 1, wherein the media track is an audio track.

13. The method of claim 1, wherein a temporal length of the voice description track is different from a temporal length of the media track.

14. The method of claim 13, wherein the voice description track includes an introductory portion prior to a start time of the media track, and wherein the user records descriptive material relating to the media track into the introductory portion of the voice description track.

15. A method of associating a voice description with time-based media, the time-based media including at least one media track, the method comprising:
receiving the time-based media at a media annotation system;
enabling a user of the media annotation system to record the user's voice description of the time-based media while using the media annotation system to play back the time-based media;
receiving from the user an identifier for an audio description track for storing the user's voice description;
creating the audio description track, wherein the audio description track is tagged by the identifier;
storing the voice description in the audio description track in association with the at least one media track as a component of a media object comprising the media track and the audio description track, wherein the audio description track is temporally synchronized with the at least one media track; and
outputting the media object from the voice annotation system.

16. A computer system for voice annotation of time-based media, the time-based media including at least one media track, the computer system comprising:
an audio input for receiving voice annotation from a user of the voice annotation system;
an output for exporting the voice annotation;
a processor programmed to:
input via the audio input the user's voice annotation of the time-based media while using the media annotation system to play back the time-based media;
create an audio annotation track for storing the user's voice annotation;
input an identifier for the audio annotation track;
store the voice annotation in the audio annotation track as a component of a media object comprising the at least one media track and the audio annotation track, wherein the audio annotation track is temporally synchronized with the at least one media track; and
export the media object from the voice annotation system via the output.

17. A computer program product comprising:
a computer-readable medium with computer program instructions encoded thereon, wherein the computer program instructions, when processed by a computer, instruct the computer to perform a method of enabling a user to annotate time-based media, wherein the time-based media includes at least one media track, the method comprising:
receiving the time-based media at a media annotation system;
enabling the user to record voice annotation of the time-based media while the computer is playing back the time-based media,
creating an audio annotation track and tagging the audio annotation track with an identifier received from the user;
storing the voice annotation in the audio annotation track, wherein the audio annotation track is stored as a component of a media object that comprises the at least one media track and the audio annotation track, and wherein the audio annotation track is temporally synchronized with the at least one media track; and
exporting the media object from the media annotation system.
